(19) United States
(12) Patent Application Publication
(10) Pub. No.: US 2025/0118807 A1
(43) Pub. Date: Apr. 10, 2025

(54) ELECTROLYTE COMPOSITION FOR A LITHIUM-ION ELECTROCHEMICAL CELL

(71) Applicant: SAFT, Levallois-Perret (FR)

(72) Inventors: Julien DEMEAUX, Bruges (FR); Marlène OSWALD, Blanquefort (FR)

(73) Assignee: SAFT, Levallois-Perret (FR)

(21) Appl. No.: 18/985,359

(22) Filed: Dec. 18, 2024

Related U.S. Application Data
(63) Continuation of application No. 16/772,060, filed on Jun. 11, 2020.

(30) Foreign Application Priority Data
Dec. 22, 2017 (FR) 1763010

(51) Int. Cl. H01M 10/0568; H01M 4/02; H01M 4/505; H01M 4/583; H01M 10/0525; H01M 10/0567; H01M 10/0569

(52) U.S. Cl. CPC H01M 10/0568; H01M 4/133; H01M 4/505; H01M 4/525; H01M 4/583; H01M 10/0525; H01M 10/0567; H01M 10/0569; H01M 10/44; H01M 2300/0037

(57) ABSTRACT

An electrolyte composition for a lithium-ion electrochemical element, comprising: at least one lithium tetrafluoride or hexafluoride salt, the salts of lithium bis(fluorosulfonyl)imide LiFSI, vinylene carbonate, ethylene sulfate, at least one organic solvent chosen from the group consisting of cyclic or linear carbonates, cyclic or linear esters, cyclic or linear ethers and a mixture thereof. The use of this composition in a lithium-ion electrochemical element increases the service life of the element, in particular under low and high temperature cycling conditions.

### CROSS REFERENCE TO RELATED APPLICATIONS

This is a Continuation Application of U.S. application Ser. No. 16/772,060 filed Jun. 11, 2020, which is a National Stage of International Application No. PCT/EP2018/086539 filed Dec. 21, 2018, claiming priority based on French Patent Application No. 1763010 filed Dec. 22, 2017. The contents of all of prior applications are incorporated herein in their respective entirety.

### TECHNICAL FIELD

The technical field of the invention is that of electrolyte compositions for lithium-ion rechargeable electrochemical cells.

### RELATED ART

Lithium-ion rechargeable electrochemical cells are known in the prior art. Due to their high mass and volume energy density, they are a promising source of electrical energy. They have at least one positive electrode, which can be a lithiated transition metal oxide, and at least one negative electrode, which can be graphite-based. However, such cells have a limited service life when used at a temperature of at least 80° C. Their constituents degrade rapidly, causing either short-circuiting of the cell or an increase in its internal resistance. For example, after about 100 charge/discharge cycles at 85° C., the capacity loss of such cells can reach 20% of their initial capacity. In addition, these cells have also been found to have a limited service life when used at temperatures below −10° C.

The aim is therefore to make available novel lithium-ion electrochemical cells with improved service life when used in cycling at a temperature of at least 80° C. or at a temperature below −10° C. This objective is considered to be achieved when these cells are capable of operating under cycling conditions by carrying out at least 200 cycles with a depth of discharge of 100% without a loss of capacity of more than 20% of their initial capacity being observed.

It is preferred that these novel electrochemical cells be capable of cycling at very low temperatures, i.e. at a temperature as low as about −20° C.

### SUMMARY OF THE INVENTION

The invention therefore relates to an electrolyte composition comprising:
at least one tetrafluorinated or hexafluorinated lithium salt,
lithium bis(fluorosulfonyl)imide (LiFSI) salt,
vinylene carbonate,
ethylene sulfate,
at least one organic solvent selected from the group consisting of cyclic or linear carbonates, cyclic or linear esters, cyclic or linear ethers and a mixture thereof.

This electrolyte can be used in a lithium-ion electrochemical cell. It enables the latter to operate at high temperatures, for example at least 80° C. It also enables the cell to operate at low temperatures, for example around −20° C.

According to an embodiment, the tetrafluorinated or hexafluorinated lithium salt is selected from lithium hexafluorophosphate LiPF₆, lithium hexafluoroarsenate LiAsF₆, lithium hexafluoroantimonate LiSbF₆ and lithium tetrafluoroborate LiBF₄.

According to an embodiment, the lithium ions from the lithium bis(fluorosulfonyl)imide salt represent at least 30 mol % of the total amount of lithium ions present in the electrolyte composition.

According to an embodiment, the lithium ions from the tetrafluorinated or hexafluorinated lithium salt make up to 70 mol % of the total amount of lithium ions present in the electrolyte composition.

According to an embodiment, the mass percentage of vinylene carbonate represents from 0.1 to 5 mass % of the mass of the group consisting of said at least one tetrafluorinated or hexafluorinated lithium salt, bis(fluorosulfonyl)imide lithium salt and said at least one organic solvent.

According to an embodiment, the mass percentage of ethylene sulfate represents from 0.1 to 5 mass % of the mass of the group consisting of said at least one tetrafluorinated or hexafluorinated lithium salt, the lithium bis(fluorosulfonyl)imide (LiFSI) salt and said at least one organic solvent.

According to an embodiment, ethylene sulfate accounts for 20 to 80 mass % of the mass of the group consisting of ethylene sulfate and vinylene carbonate and vinylene carbonate accounts for 80 to 20 mass % of the mass of the group consisting of ethylene sulfate and vinylene carbonate.

According to an embodiment, said at least one organic solvent is selected from the group consisting of cyclic carbonates, linear carbonates and mixtures thereof.

According to an embodiment, the cyclic carbonates represent from 10 to 40 mass % of the mass of the at least one organic solvent and the linear carbonates represent from 90 to 60 mass % of the at least one organic solvent.

According to an embodiment, the cyclic carbonates are selected from ethylene carbonate (EC) and propylene carbonate (PC).

The linear carbonates are selected from dimethyl carbonate (DMC) and ethyl methyl carbonate (EMC).

The invention also relates to a lithium-ion electrochemical cell comprising:
at least one negative electrode;
at least one positive electrode;
the electrolyte composition as defined above.

According to an embodiment, the negative electrode comprises a carbon-based active material, preferably graphite.

According to an embodiment, the positive active material comprises one or more of the compounds i) to v):
compound i) of formula LiₓMn_{1-y-z}M′_{y}M″_{z}PO₄, where M′ and M″ are different from each other and are selected from the group consisting of B, Mg, Al, Si, Ca, Ti, V, Cr, Fe, Co, Ni, Cu, Zn, Y, Zr, Nb and Mo, with 0.8≤x≤1.2; 0≤y≤0.6; 0≤z≤0.2;
compound ii) of formula LiₓM_{2-x-y-z-w}M′_{y}M″_{z}M″′_{w}O₂, where M, M′, M″ and M″′ are selected from the group consisting of B, Mg, Al, Si, Ca, Ti, V, Cr, Mn, Fe, Co, Ni, Cu, Zn, Y, Zr, Nb and Mo, provided that M or M′ or M″ or M′ is selected from Mn, Co, Ni, or Fe; M, M′, M″ and M″′ being different from each other; with 0.8≤x≤1.4; 0≤y≤0.5; 0≤z≤0.5; 0≤w≤0.2 and x+y+z+w<2.2;
compound iii) of formula LiₓMn_{2-y-z}M′_{y}M″_{z}O₄, where M′ and M″ are selected from the group consisting of B, Mg, Al, Si, Ca, Ti, V, Cr, Fe, Co, Ni, Cu, Zn, Y, Zr, Nb and Mo; M′ and M″ being different from each other, and 1≤x≤1.4; 0≤y≤0.6; 0≤z≤0.2;
compound iv) of formula LiₓFe_{1-y}M_{y}PO₄, where M is selected from the group consisting of B, Mg, Al, Si, Ca, Ti, V, Cr, Mn, Co, Ni, Cu, Zn, Y, Zr, Nb and Mo; and 0.8≤x≤1.2; 0≤y≤0.6;
compound v) of formula xLi₂MnO₃; (1−x)LiMO₂ where M is selected from Ni, Co and Mn and x≤1.

According to an embodiment, the positive active material comprises the compound i) with x=1; M′ represents at least one element selected from the group consisting of Fe, Ni, Co, Mg and Zn; 0<y<0.5 and z=0.

According to an embodiment, the positive active material comprises compound
ii) and
M is Ni;
M′ is Mn;
M″ is Co and
M″′ is selected from the group consisting of B, Mg, Al, Si, Ca, Ti, V, Cr, Fe, Cu, Zn, Y, Zr, Nb and Mo;
with 0.8≤x≤1.4; 0≤y≤0.5; 0≤z≤0.5; 0≤w≤0.2 and x+y+z+w<2.2.

According to an embodiment, the positive active material comprises the compound ii) and M is Ni; M′ is Co; M″ is Al; 1≤x≤1.15; y>0; z>0; w=0.

The invention also relates to the use of the electrochemical cell as described above, in storage, in charge or in discharge at a temperature of at least 80° C.

The invention also relates to the use of the electrochemical cell as described above, in storage, in charge or in discharge at a temperature lower than or equal to −20° C.

### DESCRIPTION OF THE FIGURES

FIG. 1 shows a diagram of impedance carried out at −40° C. on the reference cell A and the cell B according to the invention.

FIG. 2 shows the variation in the viscosity of the reference electrolyte composition A and the electrolyte composition B according to the invention as a function of the temperature in the range from −20° C. to 60° C.

FIG. 3 shows, at the top, the gas chromatography spectrum of the reference electrolyte composition A after it has been stored for 15 days at 85° C. The bottom spectrum is that of the electrolyte composition B according to the invention after it has been stored under the same conditions.

FIG. 4 shows the variation in the capacity of the cell A and that of the cell B during cycling at 85° C.

FIG. 5 shows the variation in the capacity of the cell A and that of the cell B during cycling at temperatures of 20° C., 0° C., −20° C., 25° C. and 85° C.

FIG. 6 shows the variation in the capacity of the cells C, D and E, during cycling at 25° C. and 60° C.

FIG. 7 shows the variation in the capacity of the cells C, F and G, during cycling at 25° C. and 60° C.

FIG. 8 shows, at the top, the gas chromatography spectrum of the electrolyte composition D at the end of the 60° C. cycling of the cell containing it. The bottom spectrum is the gas chromatography spectrum of the electrolyte composition E at the end of the 60° C. cycling of the cell containing it.

FIG. 9 shows, at the top, the gas chromatography spectrum of the electrolyte composition F at the end of the 60° C. cycling of the cell containing it. The bottom spectrum is the gas chromatography spectrum of the electrolyte composition G at the end of the 60° C. cycling of the cell containing it.

FIG. 10 shows the variation in the capacity of the cells H, I, J, K and L during cycling at 85° C.

FIG. 11 shows the variation in the capacity of the cells M, N, O, P and Q during cycling at 85° C.

FIG. 12 shows the variation in the capacity of the cells H, I, J, K and L during cycling at temperatures of 20° C., 0° C., −20° C., 25° C. and 85° C.

FIG. 13 shows the variation in the capacity of the cells M, N, O, P and Q during cycling at temperatures of 20° C., 0° C., −20° C., 25° C. and 85° C.

### DISCLOSURE OF EMBODIMENTS

The electrolyte composition according to the invention as well as the various constituents of an electrochemical cell comprising the electrolyte composition according to the invention will be described hereinbelow.

### Electrolyte Composition:

The electrolyte composition comprises at least one organic solvent in which the following compounds are dissolved:
at least one tetrafluorinated or hexafluorinated lithium salt,
lithium bis(fluorosulfonyl)imide (LiFSI) salt of formula:

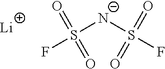

vinylene carbonate of formula:

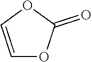

ethylene sulfate of formula:

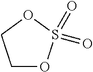

Said at least one organic solvent is selected from the group consisting of cyclic or linear carbonates, cyclic or linear esters, cyclic or linear ethers or a mixture thereof.

Examples of cyclic carbonates are ethylene carbonate (EC), propylene carbonate (PC) and butylene carbonate (BC). Ethylene carbonate (EC) and propylene carbonate (PC) are particularly preferred. The electrolyte composition may be free of cyclic carbonates other than EC and PC.

Examples of linear carbonates are dimethyl carbonate (DMC), diethyl carbonate (DEC), ethyl methyl carbonate (EMC) and propyl methyl carbonate (PMC). Dimethyl carbonate (DMC) and ethyl methyl carbonate (EMC) are particularly preferred. The electrolyte composition may be free of linear carbonates other than DMC and EMC.

The cyclic or linear carbonate(s) as well as the cyclic or linear ester(s) may be substituted by one or more halogen atoms, such as fluorine.

Examples of linear esters are ethyl acetate, methyl acetate, propyl acetate, ethyl butyrate, methyl butyrate, propyl butyrate, ethyl propionate, methyl propionate and propyl propionate.

Examples of cyclic esters are gamma-butyrolactone and gamma-valerolactone.

Examples of linear ethers are dimethoxyethane and propyl ethyl ether.

An example of a cyclic ether is tetrahydrofuran.

According to an embodiment, the electrolyte composition comprises one or more cyclic carbonates, one or more cyclic ethers and one or more linear ethers.

According to an embodiment, the electrolyte composition comprises one or more cyclic carbonates, one or more linear carbonates and at least one linear ester.

According to an embodiment, the electrolyte composition comprises one or more cyclic carbonates, one or more linear carbonates and does not comprise a linear ester. Preferably, the electrolyte composition does not comprise any solvent compounds other than the cyclic or linear carbonate(s). In the case where the solvent compounds are a mixture of cyclic and linear carbonates, the cyclic carbonate(s) may represent up to 50 mass % of the sum of the masses of the carbonates and the linear carbonate(s) may represent at least 50 mass % of the sum of the masses of the carbonates. Preferably, the cyclic carbonate(s) represent(s) 10 to 40 mass % of the mass of the carbonates and the linear carbonate(s) 90 to 60 mass % of the carbonates. A preferred organic solvent mixture is a mixture of EC, PC, EMC and DMC. EC may represent 5 to 15 mass % of the mass of the organic solvent mixture. PC may represent 15 to 25 mass % of the mass of the organic solvent mixture. EMC may represent 20 to 30 mass % of the mass of the organic solvent mixture. DMC may represent 40 to 50 mass % of the mass of the organic solvent mixture.

To prepare the electrolyte composition, at least one tetrafluorinated or hexafluorinated lithium salt and the lithium bis(fluorosulfonyl)imide (LiFSI) salt are first dissolved in said at least one organic solvent. The nature of the tetrafluorinated or hexafluorinated lithium salt is not particularly limited. Examples include lithium hexafluorophosphate LiPF₆, lithium hexafluoroarsenate LiAsF₆, lithium hexafluoroantimonate LiSbF₆ and lithium tetrafluoroborate LiBF₄. Lithium hexafluorophosphate LiPF₆ is preferably selected. Other lithium salts in addition to the tetrafluorinated or hexafluorinated lithium salt(s) and the lithium bis(fluorosulfonyl)imide (LiFSI) salt may also be dissolved in said at least one organic solvent. Preferably, the electrolyte composition does not contain any lithium salts other than the tetrafluorinated or hexafluorinated lithium salt(s) and the lithium bis(fluorosulfonyl)imide (LiFSI) salt. In particular, it contains neither lithium difluorophosphate LiPO₂F₂ nor lithium difluoro(oxalato)borate LiBF₂(C₂O₄) (LiDFOB). LiPO₂F₂ is weakly dissociated. The Li⁺ PO₂F₂⁻ form is almost non-existent. An electrolyte resulting from and using this salt would have a conductivity far too low to be used in a Li-ion battery. Due to its low ionicity, LiPO₂F₂ is very poorly soluble in the electrolyte. Its concentration can therefore not exceed 0.1 mol/L. On the other hand, the presence of LiDFOB can lead to excessive gas generation during its decomposition into reduction and oxidation. In addition, the electrolyte incorporating this salt has a low ionic conductivity.

Preferably still, the only lithium salts in the electrolyte composition are LiPF₆ and LiFSI.

The total lithium ion concentration in the electrolyte composition is generally between 0.1 and 3 mol/L, preferably between 0.5 and 1.5 mol/L, more preferably about 1 mol/L.

The lithium ions from the tetrafluorinated or hexafluorinated lithium salt generally represent up to 70% of the total amount of lithium ions present in the electrolyte composition. They can further account for 1 to 70% of the total amount of lithium ions in the electrolyte composition. They can further make up 10 to 70% of the total amount of lithium ions in the electrolyte composition.

Lithium ions from the lithium bis(fluorosulfonyl)imide salt generally represent at least 30% of the total amount of lithium ions present in the electrolyte composition. They may further account for 30 to 99% of the total amount of lithium ions present in the electrolyte composition. They may further account for 30 to 90% of the total amount of lithium ions in the electrolyte composition.

In a second step, vinylene carbonate and ethylene sulfate are added to the mixture containing said at least one organic solvent and the lithium salts. These compounds act as an additive contributing to the stabilization of the passivation layer which forms on the surface of the negative electrode of the electrochemical cell during the first charge/discharge cycles of the cell. Additives other than vinylene carbonate and ethylene sulfate may also be added to the mixture.

In a preferred embodiment, the electrolyte composition contains no additives other than vinylene carbonate and ethylene sulfate. In particular, the electrolyte composition does not contain sultone(s). The presence of sultone(s) has a disadvantage compared with ethylene sulfate in that the passivation layer (SEI) on the surface of the negative electrode is less conductive in cold applications than when ethylene sulfate is present. In addition, for hot applications, the passivation layer on the surface of the negative electrode is stronger and less soluble in the electrolyte when ethylene sulfate is present than when a sultone is present.

The amount of additive introduced into the mixture is measured by mass relative to the mass of the group consisting of the tetrafluorinated or hexafluorinated lithium salt(s), the lithium bis(fluorosulfonyl)imide (LiFSI) salt and said at least one organic solvent.

According to an embodiment, the mass percentage of vinylene carbonate represents from 0.1 to 5, preferably from 0.5 to 3, more preferably from 1 to 2 mass % of the mass of the group consisting of the tetrafluorinated or hexafluorinated lithium salt(s), the lithium bis(fluorosulfonyl)imide salt and said at least one organic solvent.

According to an embodiment, the mass percentage of ethylene sulfate represents from 0.1 to 5, preferably from 0.5 to 2, more preferably from 1 to 2 mass % of the mass of the group consisting of the tetrafluorinated or hexafluorinated lithium salt(s), the lithium bis(fluorosulfonyl)imide salt and said at least one organic solvent.

Ethylene sulfate may represent from 20 to 80 mass % or 30 to 50 mass % of the total mass of ethylene sulfate and vinylene carbonate. Vinylene carbonate may represent from 80 to 20 mass % or 50 to 30 mass % of the combined mass of ethylene sulfate and vinylene carbonate.

A preferred electrolyte composition comprises:
from 0.1 to 0.7 mol/L of at least one tetrafluorinated or hexafluorinated lithium salt, preferably LiPF₆;
from 0.3 to 0.9 mol/L of the lithium bis(fluorosulfonyl)imide (LiFSI) salt;
from 1 to 3 mass % of vinylene carbonate, preferably 2 mass % of the mass of the group consisting of the tetrafluorinated or hexafluorinated lithium salt(s), the lithium bis(fluorosulfonyl)imide salt and said at least one organic solvent;
from 0.5 to 2 mass % of ethylene sulfate, preferably 1 mass % of the mass of the group consisting of the tetrafluorinated or hexafluorinated lithium salt(s), the lithium bis(fluorosulfonyl)imide salt and said at least one organic solvent.

Another preferred electrolyte composition comprises:
from 0.6 to 0.8 mol/L of at least one tetrafluorinated or hexafluorinated lithium salt, preferably LiPF₆;
from 0.2 to 0.4 mol/L of the lithium bis(fluorosulfonyl)imide (LiFSI) salt;
from 1 to 3 mass % of vinylene carbonate, preferably 2 mass % of the mass of the group consisting of the tetrafluorinated or hexafluorinated lithium salt(s), the lithium bis(fluorosulfonyl)imide salt and said at least one organic solvent;
from 0.5 to 2 mass % of ethylene sulfate, preferably 1 mass % of the mass of the group consisting of the tetrafluorinated or hexafluorinated lithium salt(s), the lithium bis(fluorosulfonyl)imide salt and said at least one organic solvent.

Another preferred electrolyte composition comprises:
from 0.05 to 0.2 mol/L of at least one tetrafluorinated or hexafluorinated lithium salt, preferably LiPF₆;
from 0.8 to 0.95 mol/L of the lithium bis(fluorosulfonyl)imide (LiFSI) salt;
from 1 to 3 mass % of vinylene carbonate, preferably 2 mass % of the mass of the group consisting of the tetrafluorinated or hexafluorinated lithium salt(s), the lithium bis(fluorosulfonyl)imide salt and said at least one organic solvent;
from 0.5 to 2 mass % of ethylene sulfate, preferably 1 mass % of the mass of the group consisting of the tetrafluorinated or hexafluorinated lithium salt(s), the lithium bis(fluorosulfonyl)imide salt and said at least one organic solvent.

Another preferred electrolyte composition comprises:
0.7 mol/L of LiPF₆;
0.3 mol/L of the lithium bis(fluorosulfonyl)imide (LiFSI) salt;
2 mass % of vinylene carbonate relative to the mass of the group consisting of the tetrafluorinated or hexafluorinated lithium salt(s), the lithium bis(fluorosulfonyl)imide salt and said at least one organic solvent;
1 mass % of ethylene sulfate relative to the mass of the group consisting of the tetrafluorinated or hexafluorinated lithium salt(s), the lithium bis(fluorosulfonyl)imide salt and said at least one organic solvent.

Another preferred electrolyte composition comprises:
0.1 mol/L of LiPF₆;
0.9 mol/L of the lithium bis(fluorosulfonyl)imide (LiFSI) salt;
2 mass % of vinylene carbonate relative to the mass of the group consisting of the tetrafluorinated or hexafluorinated lithium salt(s), the lithium bis(fluorosulfonyl)imide salt and said at least one organic solvent;
1 mass % of ethylene sulfate relative to the mass of the group consisting of the tetrafluorinated or hexafluorinated lithium salt(s), the lithium bis(fluorosulfonyl)imide salt and said at least one organic solvent.

### Negative Active Material:

The active material of the negative electrode (anode) of the electrochemical cell is preferably a carbonaceous material which can be selected from graphite, coke, carbon black and vitreous carbon.

In another preferred embodiment, the active material of the negative electrode contains a silicon-based compound.

### Positive Active Material:

The positive active material of the positive electrode (cathode) of the electrochemical cell is not particularly limited. It can be selected from the group consisting of:
a compound i) of formula LiₓMn_{1-y-z}M′_{y}M″_{z}PO₄ (LMP), where M′ and M″ are different from each other and are selected from the group consisting of B, Mg, Al, Si, Ca, Ti, V, Cr, Fe, Co, Ni, Cu, Zn, Y, Zr, Nb and Mo, with 0.8≤x≤1.2; 0≤y≤0.6; 0≤z≤0.2;
a compound ii) of formula LiₓM_{2-x-y-z-w}M′_{y}M″_{z}M″′_{w}O₂ (LMO2), where M, M′, M″ and M″′ are selected from the group consisting of B, Mg, Al, Si, Ca, Ti, V, Cr, Mn, Fe, Co, Ni, Cu, Zn, Y, Zr, Nb, W and Mo, provided that M or M′ or M″ or M′ is selected from Mn, Co, Ni, or Fe; M, M′, M″ and M″′ being different from each other; with 0.8≤x≤1.4; 0≤y≤0.5; 0≤z≤0.5; 0≤w≤0.2 and x+y+z+w<2.2;
a compound iii) of formula LiₓMn_{2-y-z}M′_{y}M″_{z}O₄ (LMO), where M′ and M″ are selected from the group consisting of B, Mg, Al, Si, Ca, Ti, V, Cr, Fe, Co, Ni, Cu, Zn, Y, Zr, Nb and Mo; M′ and M″ being different from each other, and 1≤x≤1.4; 0≤y≤0.6; 0≤z≤0.2;
a compound iv) of formula LiₓFe_{1-y}M_{y}PO₄, where M is selected from the group consisting of B, Mg, Al, Si, Ca, Ti, V, Cr, Mn, Co, Ni, Cu, Zn, Y, Zr, Nb and Mo; and 0.8≤x≤1.2; 0≤y≤0.6;
a compound v) of formula xLi₂MnO₃; (1−x)LiMO₂ where M is selected from Ni, Co and Mn and x≤1,
or a mixture of compounds i) to v).

An example of compound i) is LiMn_{1-y}Fe_{y}PO₄. A preferred example is LiMnPO₄.

Compound ii) may have the formula LiₓM_{2-x-y-z-w}M′_{y}M″_{z}M″′_{w}O₂, where 1≤x≤1.15; M denotes Ni; M′ denotes Mn; M″ denotes Co and M″′ is selected from the group consisting of B, Mg, Al, Si, Ca, Ti, V, Cr, Fe, Cu, Zn, Y, Zr, Nb, Mo or a mixture thereof; 2−x−y−z−w>0; y>0; z>0; w≥0.

Compound ii) may have the formula LiNi_{1/3}Mn_{1/3}Co_{1/3}O₂.

Compound ii) may also have the formula LiₓM_{2-x-y-z-w}M′_{y}M″_{z}M″′_{w}O₂, where 1≤x≤1.15; M denotes Ni; M′ denotes Co; M″ denotes Al and M″′ is selected from the group consisting of B, Mg, Si, Ca, Ti, V, Cr, Fe, Cu, Zn, Y, Zr, Nb, Mo or a mixture thereof; 2−x−y−z−w>0; y>0; z>0; w≥0. Preferably x=1; 0.6≤2−x−y−z≤0.85; 0.10≤y≤0.25; 0.05≤z≤0.15 and w=0.

Compound ii) may also be selected from LiNiO₂, LiCoO₂, LiMnO₂, Ni, Co and Mn which may be substituted by one or more of the cells selected from the group consisting of Mg, Mn (except for LiMnO₂), Al, B, Ti, V, Si, Cr, Fe, Cu, Zn, Zr.

An example of compound iii) is LiMn₂O₄.

An example of compound iv) is LiFePO₄.

An example of compound v) is Li₂MnO₃.

The positive active material may be at least partially covered by a layer of carbon.

### Binder for the Positive and Negative Electrodes:

The positive and negative active materials of the lithium-ion electrochemical cell are generally mixed with one or more binder(s), the function of which is to bind the active material particles together and to bind them to the current collector on which they are deposited.

The binder may be selected from carboxymethylcellulose (CMC), styrene-butadiene copolymer (SBR), polytetrafluoroethylene (PTFE), polyamideimide (PAI), polyimide (PI), styrene-butadiene rubber (SBR), polyvinyl alcohol, polyvinylidene fluoride (PVDF) and a mixture thereof. These binders can typically be used in the positive electrode and/or the negative electrode.

Current Collector for the Positive and/or Negative Electrodes:

The current collector for the positive and negative electrodes is in the form of a solid or perforated metal foil. The foil can be made from different materials. Examples include copper or copper alloys, aluminum or aluminum alloys, nickel or nickel alloys, steel and stainless steel.

The current collector of the positive electrode is usually a foil made of aluminum or an alloy containing mostly aluminum. The current collector of the negative electrode is usually a foil made of copper or an alloy containing mostly copper. The thickness of the positive electrode foil may be different from that of the negative electrode foil. The foil of the positive or negative electrode is generally between 6 and 30 μm thick.

According to a preferred embodiment, the aluminum collector of the positive electrode is covered with a conductive coating, for example carbon black, graphite.

### Manufacture of the Negative Electrode:

The negative active material is mixed with one or more of the above-mentioned binders and optionally a good electronically conductive compound, such as carbon black. The result is an ink that is deposited on one or both sides of the current collector. The ink-coated current collector is laminated to adjust its thickness. A negative electrode is thus obtained.

The composition of the ink deposited on the negative electrode can be as follows:
from 75 to 96% negative active material, preferably from 80 to 85%;
from 2 to 15% binder(s), preferably 5%;
from 2 to 10% electronically conductive compound, preferably 7.5%.

### Manufacture of the Positive Electrode:

The same procedure is used as for the negative electrode but starting from positive active material.

The composition of the ink deposited on the positive electrode can be as follows:
from 75 to 96% negative active material, preferably 80 to 90%;
from 2 to 15% binder(s), preferably 10%;
from 2 to 10% carbon, preferably 10%.

### Separator:

The material of the separator can be selected from the following materials: a polyolefin, for example polypropylene, polyethylene, a polyester, polymer-bonded glass fibers, polyimide, polyamide, polyaramide, polyamideimide and cellulose. The polyester can be selected from polyethylene terephthalate (PET) and polybutylene terephthalate (PBT). Advantageously, the polyester or the polypropylene or the polyethylene contains or is coated with a material selected from the group consisting of a metal oxide, a carbide, a nitride, a boride, a silicide and a sulfide. This material can be SiO₂ or Al₂O₃.

### Preparation of the Electrochemical Assembly:

An electrochemical assembly is formed by interposing a separator between at least one negative electrode and at least one positive electrode. The electrochemical assembly is inserted into the cell container. The cell container can be of parallelepipedal or cylindrical format. In the latter case, the electrochemical assembly is coiled to form a cylindrical electrode assembly.

### Filling of the Container:

The container provided with the electrochemical assembly is filled with the electrolyte composition as described above.

A cell according to the invention typically comprises the combination of the following constituents:
a) at least one positive electrode whose active material is a lithium oxide of transition metals comprising nickel, manganese and cobalt;
b) at least one negative electrode whose active material is graphite;
c) an electrolyte composition as described above;
d) a polypropylene separator.

The applicant found that the combination of the two lithium salts, i.e. tetrafluorinated or hexafluorinated lithium salt and lithium bis(fluorosulfonyl)imide (LiFSI) salt with the two additives, i.e. vinylene carbonate and ethylene sulfate, provided the following advantages:
The impedance of the electrochemical cell is reduced.
The electrochemical cell can operate over a wide temperature range, i.e. from −10° C. or even −20° C., up to a temperature of up to 80° C. or even 100° C.
The electrochemical cell has good cold power down to −40° C.
The electrochemical cell can be subjected to cycling with significant variations in ambient temperature.
The electrochemical cell loses capacity less rapidly when used under cycling conditions. The invention therefore makes it possible to extend the service life of a cell operating under cycling conditions, whether it is used at low or high temperatures.
The formation of gas in the case of the cells with a graphite-based anode is reduced.
The self-discharge rate of the cell is reduced.
The viscosity of the electrolyte composition is reduced.

It is therefore preferable that the electrolyte does not contain any lithium salt other than the tetrafluorinated or hexafluorinated lithium salt(s) and the lithium bis(fluorosulfonyl)imide (LiFSI) salt and does not contain any additive other than vinylene carbonate and ethylene sulfate.

### EXAMPLES

Lithium-ion electrochemical cells were manufactured. They comprise a negative electrode whose active material is graphite and a positive electrode whose active material has the formula LiNi_{1/3}Mn_{1/3}Co_{1/3}O₂. The separator is made of polypropylene. The cell containers were filled with an electrolyte whose composition is designated A to Q. Table 1 below shows the different electrolyte compositions A to Q. For convenience, the electrochemical cells will be referred to in the following by reference to the electrolyte composition they contain.

TABLE 1

| Electrolyte | Organic | LiPF₆ | LiFSI | VC | ESA |
|---|---|---|---|---|---|
| composition | solvent ** | (mol/L) | (mol/L) | (%)*** | (%)*** |
| A* | EC:PC:EMC:DMC | 1.0 | — | 3 | — |
| | 10:20:25:45 | | | | |
| B* | EC:PC:EMC:DMC | 0.1 | 0.9 | 2 | 1 |
| | 10:20:25:45 | | | | |
| C* | EMC | 1.0 | — | — | — |
| D* | EMC | 1.0 | — | 5 | — |
| E* | EMC | 1.0 | — | — | 5 |
| F* | EMC | 1.0 | — | 2 | — |
| G* | EMC | 1.0 | — | 2 | 2 |
| H* | EC:PC:EMC:DMC | 1 | — | 1 | — |
| | 10:20:25:45 | | | | |
| I* | EC:PC:EMC:DMC | 0.7 | 0.3 | 1 | — |
| | 10:20:25:45 | | | | |
| J* | EC:PC:EMC:DMC | 0.5 | 0.5 | 1 | — |
| | 10:20:25:45 | | | | |
| K* | EC:PC:EMC:DMC | 0.3 | 0.7 | 1 | — |
| | 10:20:25:45 | | | | |
| L* | EC:PC:EMC:DMC | 0.1 | 0.9 | 1 | — |
| | 10:20:25:45 | | | | |
| M* | EC:PC:EMC:DMC | 1 | — | 1 | 1 |
| | 10:20:25:45 | | | | |
| N* | EC:PC:EMC:DMC | 0.7 | 0.3 | 1 | 1 |
| | 10:20:25:45 | | | | |
| O* | EC:PC:EMC:DMC | 0.5 | 0.5 | 1 | 1 |
| | 10:20:25:45 | | | | |
| P* | EC:PC:EMC:DMC | 0.3 | 0.7 | 1 | 1 |
| | 10:20:25:45 | | | | |
| Q* | EC:PC:EMC:DMC | 0.1 | 0.9 | 1 | 1 |
| | 10:20:25:45 | | | | |

*Electrolyte composition not being part of the invention
** Mass ratios
***Mass percentage expressed in relation to the sum of the masses of organic solvents, LiPF₆ and LiFSI if present

### a) Effect of the Combination of LiFSI Vinylene Carbonate and Ethylene Sulfate on a Reference Composition Comprising LiPF₆ and Vinylene Carbonate as Sole Additive:

The cell A comprises a reference electrolyte comprising LiPF₆ at a concentration of 1 mol/L and 3 mass % of vinylene carbonate. The cell B comprises an electrolyte according to the invention which differs from that of the cell A in that part of LiPF₆ has been substituted by LiFSI and in that part of the vinylene carbonate has been substituted by ethylene sulfate. Ninety percent of the molar amount of LiPF₆ salt has been substituted by LiFSI and one third of the mass of vinylene carbonate has been substituted by ethylene sulfate.

The cells A and B underwent an electrochemical formation cycle at 60° C. involving charging at regime C/10, followed by discharging at regime C/10, where C is the nominal capacity of the cells. The electrochemical impedance spectra of the cells A and B in open circuit were then plotted over a frequency range of 1 kHz to 10 mHz at a temperature of −40° C. The impedance spectra obtained are shown in FIG. 1. It can be seen that for a frequency below about 0.01 Hz, the impedance of the cell B is lower than that of the cell A, which is beneficial for the service life of the cell.

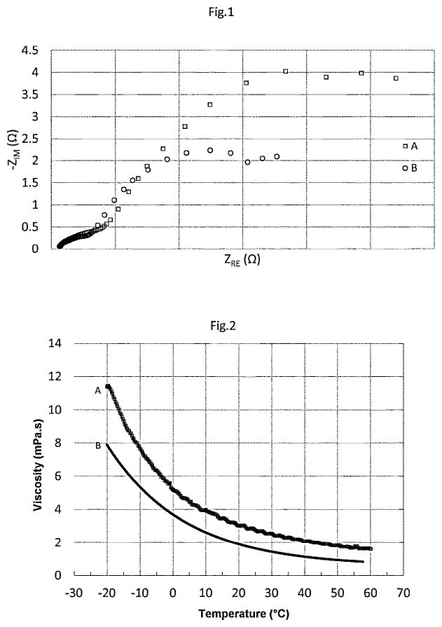

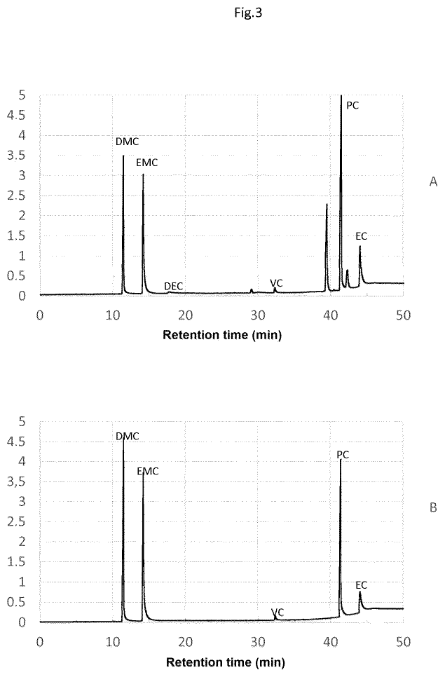

The viscosity of the electrolyte compositions A and B was measured for a temperature ranging from −20° C. to 60° C. The variation of viscosity with temperature is shown in FIG. 2, which shows that the viscosity of the electrolyte composition B is lower than that of the electrolyte composition A. This reduction in viscosity has the advantage of significantly reducing the filling time of a cell.

The electrolyte compositions A and B were stored at a temperature of 85° C. for two weeks. At the end of this storage period they were analyzed by gas chromatography. The spectra obtained are shown in FIG. 3. The upper spectrum is that of the composition A, the lower is that of the composition B. The spectrum obtained for the composition A shows the peaks corresponding to DMC, EMC, VC, PC and EC at the respective retention times of 11, 14, 32, 41 and 44 min. It also shows two peaks of high intensity at retention times of 39 and 42 min, and peaks of low intensity at retention times of 18 and 29 min. The peaks at retention times 18, 29, 39 and 42 minutes are attributed to products formed by the decomposition of the electrolyte during the storage period at 85° C. In comparison, the spectrum of the composition B does not show any of the peaks at the retention times of 18, 29, 39 and 42 minutes. This indicates that the electrolyte composition B decomposes less rapidly than the composition A.

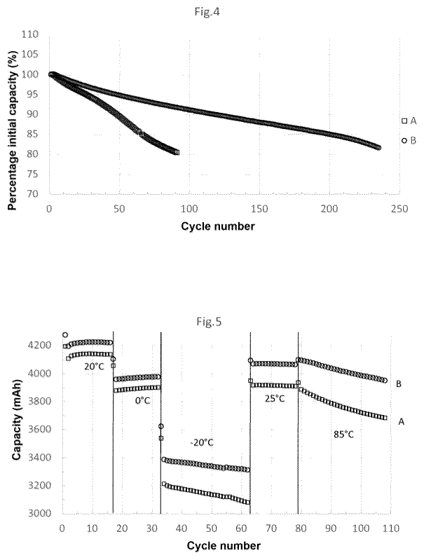

The cells A and B were cycled at a temperature of 85° C. Each cycle consists of a charge phase at regime C/3 speed followed by a discharge phase at regime C/3 to a depth of discharge of 100%. The capacity discharged by the cells is measured during cycling. The variation is shown in FIG. 4, which shows that in cycle 50 the capacity loss of the cell A is 10% and the capacity loss of the cell B is only 5%. In cycle 90, the cell A lost 20% of its original capacity. It has therefore reached the end-of-service life criterion after 90 cycles. In comparison, at the same cycle number, the cell B lost only 8% of its initial capacity. The cell B has a reduced loss of capacity because after 235 cycles, the capacity loss is still less than 20%.

The cells A and B were then cycled with large temperature variations. The various characteristics of the cycling are shown in Table 2 below.

TABLE 2

| Number | | Charge or |
|---|---|---|
| of cycles | | discharge |
| performed | Temperature | current |
| 1 | 20° C. | C/10 |
| 15 | 20° C. | C/3 |
| 1 | 0° C. | C/10 |
| 15 | 0° C. | C/3 |
| 1 | −20° C. | C/10 |
| 30 | −20° C. | C/3 |
| 1 | 25° C. | C/10 |
| 15 | 25° C. | C/3 |
| 1 | 85° C. | C/10 |
| 30 | 85° C. | C/3 |

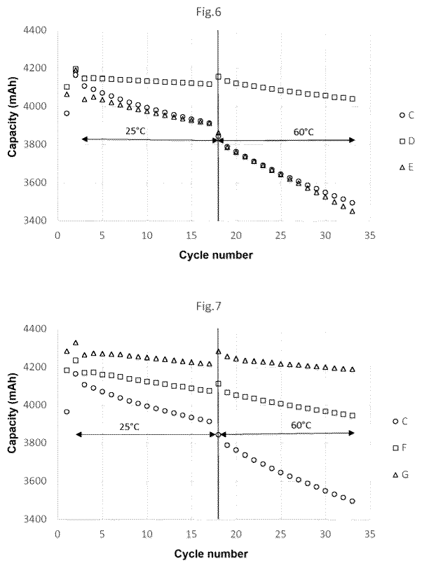

FIG. 5 shows the change in the discharged capacity of the cells A and B. It shows on the one hand that, irrespective of the cycling temperature, the capacity discharged by the cell B is higher than that of the cell A. It also shows on the other hand that at −20° C., the cell B loses its capacity less rapidly than the cell A. Indeed, the loss of capacity of the cell B is −2.5 mAh per cycle whereas it is −4.2 mAh per cycle for the cell A. The service life of the cell B is longer than that of the cell A. The capacity loss of the cell B at −20° C. over 200 cycles is therefore 0.5 Ah, which represents a loss of 12% of its initial capacity, below the 20% limit. The objective sought by the present invention is therefore well achieved.

In conclusion, FIGS. 1 to 5 illustrate the benefit of the combination of the two lithium salts, i.e. the hexafluorinated lithium salt and the lithium bis(fluorosulfonyl)imide (LiFSI) salt with the two additives, i.e. vinylene carbonate and ethylene sulfate.

### b) Synergistic Effect of the Combination of Vinylene Carbonate and Ethylene Sulfate

The following tests demonstrate the existence of a synergy between vinylene carbonate and ethylene sulfate. Cells comprising the electrolyte compositions C, D, E, F and G described in Table 1 above were manufactured. They were cycled through the following phases:
1 cycle at a temperature of 60° C. at regime C/10;
1 cycle at a temperature of 25° C. at regime C/10;
15 cycles at a temperature of 25° C. at regime C/5;
1 cycle at a temperature of 60° C. at regime C/10;
15 cycles at a temperature of 60° C. at regime C/5.

FIG. 6 shows the change in the discharged capacity of the cells C, D and E during cycling. Comparison between the curve for the cell D and that of the cell C shows that the addition of 5% vinylene carbonate helps to slow down the loss of capacity during cycling. On the other hand, a comparison between the curve for the cell E and that of the cell C shows that the addition of 5% ethylene sulfate has almost no effect on slowing down the capacity loss of the cell.

FIG. 7 shows the change in the discharged capacity of the cells C, F and G during cycling. Comparison of the curve for the cell F with that for the cell C shows that the addition of 2% vinylene carbonate helps to slow down the loss of capacity during cycling, but to a lesser extent than for an addition of 5% vinylene carbonate (cell D). The Applicant has found surprisingly that when 2% ethylene sulfate is added to the composition of the cell F containing 2% vinylene carbonate, there is an increase in the discharged capacity on the one hand and a slowing down of the loss of capacity of the cell during cycling (cell G) on the other hand. This result is surprising in view of the results obtained with cell E, which show that the addition of 5% ethylene sulfate as the sole additive has practically no effect either on the capacity discharged or on slowing down the loss of capacity of the cell. Furthermore, it can be seen that the capacity of the cell G containing the combination of 2% vinylene carbonate with 2% ethylene sulfate has a higher unloaded capacity than the cell D containing 5% vinylene carbonate. In fact, the capacity of the cell G at the 33rd cycle is close to 4200 mAh while that of the cell D is much less than 4200 mAh. The cell G therefore has a higher capacity than the cell D for a lower percentage of additive (4% instead of 5%).

The Applicant is of the opinion that the combination of vinylene carbonate with ethylene sulfate stabilizes the passivation layer on the surface of the negative electrode. The passivation layer forms a shield that prevents the electrolyte from coming into contact with the negative electrode and decomposing. As the passivation layer is made more stable, it provides additional protection against electrolyte decomposition.

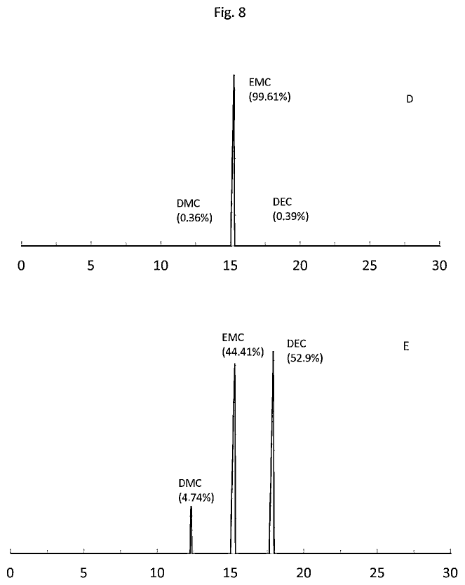

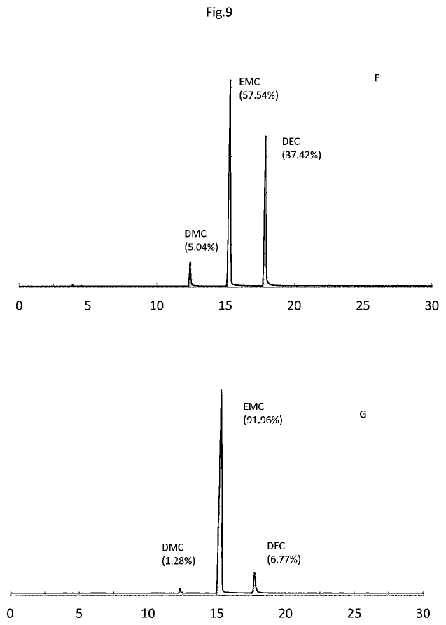

In order to test this hypothesis, the Applicant compared by gas chromatography the electrolyte compositions of the cells D, E, F and G after they had been cycled as in FIGS. 6 and 7. The resulting spectra are shown in FIGS. 8 and 9.

The bottom spectrum in FIG. 8 is that of the cell E whose electrolyte composition includes 5% ethylene sulfate as the sole additive. It shows three peaks attributable to DMC, EMC, and DEC. This indicates that during cycling, EMC, which was the only organic solvent in the electrolyte composition, decomposed into DMC and DEC. The amounts of DMC and DEC are similar to those obtained for an electrolyte composition comprising EMC and LiPF₆, without additive (cell C). The presence of ethylene sulfate alone does not provide a stable passivation layer.

By way of comparison, the top spectrum in FIG. 8 is that of the cell D containing 5% vinylene carbonate as an additive. This spectrum shows that the peaks attributed to DMC and DEC have almost disappeared, which indicates that the addition of 5% vinylene carbonate is sufficient to stabilize the passivation layer and prevent the decomposition of EMC to DMC and DEC. Of the initial amount of vinylene carbonate, 96.4% was consumed by the formation of the passivation layer.

Comparison of the spectra in FIG. 9 shows the effect provided by the presence of ethylene sulfate in combination with vinylene carbonate in the electrolyte. The top spectrum in FIG. 9 is that of the cell F with 2% vinylene carbonate. It shows three peaks attributed to DMC, EMC and DEC. Of the initial amount of vinylene carbonate, 100% was consumed by the formation of the passivation layer. Therefore, the vinylene carbonate peak does not appear in the spectrum.

The bottom spectrum in FIG. 9 is the spectrum of the cell G comprising 2% vinylene carbonate and 2% ethylene sulfate. It shows a significant decrease in the intensity of the peaks attributed to DMC and DEC. This therefore indicates a decrease in the amount of the decomposition products DMC and DEC and confirms that the combination of vinylene carbonate and ethylene sulfate stabilizes the passivation layer. It also reduces the irreversible capacity of the cell and increases the coulombic yield. Of the initial amount of vinylene carbonate, 100% was consumed by the formation of the passivation layer.

### c) Influence of the Rate of Substitution of LiPF₆ by LiFSI:

Electrolyte compositions with different rates of substitution of LiPF₆ by LiFSI were prepared. These are the compositions H, I, J, K and L in which the molar substitution rate of LiPF₆ by LiFSI is 0%, 30%, 50%, 70% and 90% respectively. The additive used is vinylene carbonate in a mass percentage of 1%.

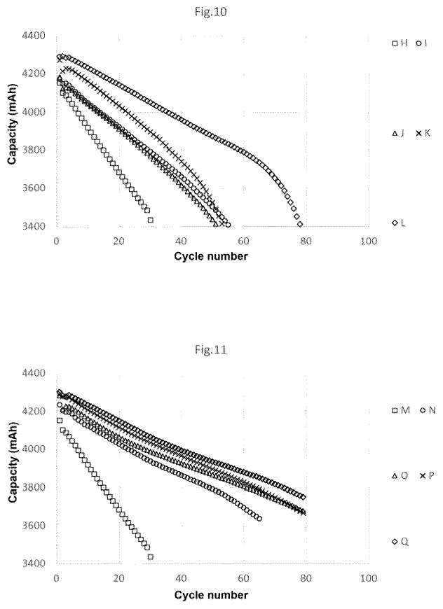

The cells containing the electrolyte compositions H to L were subjected to a cycling test at a temperature of 85° C. Charging and discharging was carried out at regime C/3. The depth of discharge was 100%. The variation in the discharged capacity is shown in FIG. 10. It shows that a failure of the cell H whose electrolyte does not contain LiFSI occurs as early as the 30th cycle. The curves for the cells I to L show that the service life of these cells is extended compared with that of the cell H, thanks to the substitution of LiPF₆ by LiFSI. The greatest improvement in service life is obtained for the cell L, where the molar substitution rate of LiPF₆ by LiFSI is 90%. The service life is improved by a factor of about 2.7 compared with the cell H.

Electrolyte compositions with different rates of substitution of LiPF₆ by LiFSI were prepared. These are compositions M, N, O, P and Q in which the molar substitution rate of LiPF₆ by LiFSI is 0%, 30%, 50%, 70% and 90% respectively. The additives used in these compositions are vinylene carbonate and ethylene sulfate, each in a mass percentage of 1%.

The cells containing the compositions M to Q were subjected to a cycling test at a temperature of 85° C. Charging and discharging was carried out at regime C/3. The depth of discharge was 100%. The variation in the capacity discharged by the cells is shown in FIG. 11. It shows that the combination of ethylene sulfate with vinylene carbonate in the absence of LiFSI leads to a short service life. In fact, a failure of the cell M whose electrolyte does not contain LiFSI occurs as early as the 30th cycle. The curves for the cells N to Q show that the service life of these cells is extended by replacing LiPF₆ with LiFSI. The greatest improvement in service life is obtained for the cell Q, whose composition has a molar substitution rate of LiPF₆ by LiFSI of 90%. The service life is improved by a factor of more than 2.7 compared with the cell M.

These results show that for a given rate of substitution of LiPF₆ by LiFSI, the service life of a cell is extended when the electrolyte composition contains the combination of ethylene sulfate with vinylene carbonate compared with an electrolyte composition containing only vinylene carbonate as the sole additive.

The cells H to Q were then cycled through the different phases as shown in Table 3 below:

TABLE 3

| Number | | Charge or |
|---|---|---|
| of cycles | | discharge |
| performed | Temperature | current |
| 1 | 20° C. | C/10 |
| 15 | 20° C. | C/3 |
| 1 | 0° C. | C/10 |
| 15 | 0° C. | C/3 |
| 1 | −20° C. | C/10 |
| 15 | −20° C. | C/3 |
| 1 | 25° C. | C/10 |
| 15 | 25° C. | C/3 |
| 1 | 85° C. | C/10 |
| 15 | 85° C. | C/3 |

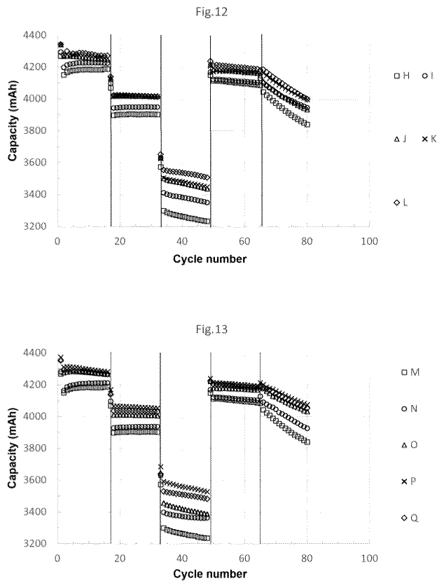

FIG. 12 shows the variation in the discharged capacity of the cells H to L during cycling. FIG. 13 shows the change in the discharged capacity of the cells M to Q during cycling. The cells N to Q, which are according to the invention and which contain vinylene carbonate combined with ethylene sulfate as additives, have a greater discharge capacity than the cells I to L, which contain only vinylene carbonate as the sole additive. It can also be seen that the benefit of adding ethylene sulfate in a mixture with vinylene carbonate is manifested above all during a high-temperature cycling phase, when this follows a low-temperature cycling phase.

1. An electrolyte composition comprising:
lithium hexafluorophosphate (LiPF₆),
lithium bis(fluorosulfonyl)imide (LiFSI) salt,
vinylene carbonate,
ethylene sulfate,
lithium difluorophosphate (LiPO₂F₂) at a concentration not exceeding 0.1 mol·L⁻¹,
at least one organic solvent selected from the group consisting of cyclic or linear carbonates, cyclic or linear esters, cyclic or linear ethers and a mixture thereof,
wherein the electrolyte composition does not comprise any additive other than vinylene carbonate and ethylene sulfate, and
wherein the electrolyte composition does not comprise any salt other than LiPF₆, LiFSI and LiPO₂F₂.

2. The electrolyte composition as claimed in claim 1 consisting of:
lithium hexafluorophosphate (LiPF₆),
lithium bis(fluorosulfonyl)imide (LiFSI) salt,
vinylene carbonate,
ethylene sulfate,
lithium difluorophosphate (LiPO₂F₂) at a concentration not exceeding 0.1 mol·L⁻¹,
at least one organic solvent selected from the group consisting of cyclic or linear carbonates, cyclic or linear esters, cyclic or linear ethers and a mixture thereof.

3. The electrolyte composition as claimed in claim 1, wherein the lithium ions from the lithium bis(fluorosulfonyl)imide salt represent at least 30% of the total amount of lithium ions present in the electrolyte composition.

4. The electrolyte composition as claimed in claim 1, wherein the lithium ions from the lithium hexafluorophosphate represent up to 70% of the total amount of lithium ions present in the electrolyte composition.

5. The electrolyte composition as claimed in claim 1, wherein the mass percentage of vinylene carbonate represents from 0.1 to 5 mass % of the mass of the group consisting of the lithium hexafluorophosphate, the lithium bis(fluorosulfonyl)imide salt and said at least one organic solvent.

6. The electrolyte composition as claimed in claim 1, wherein the mass percentage of ethylene sulfate is from 0.1 to 5 mass % of the mass of the group consisting of the lithium hexafluorophosphate, the lithium bis(fluorosulfonyl)imide (LiFSI) salt and said at least one organic solvent.

7. The electrolyte composition as claimed in claim 1, wherein:
the ethylene sulfate represents from 20 to 80 mass % of the mass of the group consisting of ethylene sulfate and vinylene carbonate, and
vinylene carbonate represents from 80 to 20 mass % of the mass of the group consisting of ethylene sulfate and vinylene carbonate.

8. The electrolyte composition as claimed in claim 1, wherein said at least one organic solvent is selected from the group consisting of cyclic carbonates, linear carbonates and mixtures thereof.

9. The electrolyte composition as claimed in claim 8, wherein the cyclic carbonates represent from 10 to 40 mass % of the mass of said at least one organic solvent and the linear carbonates represent from 90 to 60% of the mass of said at least one organic solvent.

10. The electrolyte composition as claimed in claim 8, wherein the cyclic carbonates are selected from ethylene carbonate (EC) and propylene carbonate (PC).

11. The electrolyte composition as claimed in claim 8, wherein the linear carbonates are selected from dimethyl carbonate (DMC) and ethyl methyl carbonate (EMC).

12. The electrolyte composition as claimed in claim 1 consisting of:
at least one organic solvent selected from the group consisting of cyclic or linear carbonates, cyclic or linear esters, cyclic or linear ethers and a mixture thereof,
lithium hexafluorophosphate (LiPF₆),
lithium bis(fluorosulfonyl)imide (LiFSI) salt,
from 0.5 to 3% of vinylene carbonate based on the mass of the group consisting of LiPF₆, LiFSI and said at least one organic solvent selected from the group consisting of cyclic or linear carbonates, cyclic or linear esters, cyclic or linear ethers and a mixture thereof,
from 0.5 to 2% of ethylene sulfate based on the mass of the group consisting of LiPF₆, LiFSI and said at least one organic solvent selected from the group consisting of cyclic or linear carbonates, cyclic or linear esters, cyclic or linear ethers and a mixture thereof,
lithium difluorophosphate (LiPO₂F₂) at a concentration not exceeding 0.1 mol·L⁻¹.

13. A lithium-ion electrochemical cell comprising:
at least one negative electrode;
at least one positive electrode;
the electrolyte composition as claimed in claim 1.

14. The lithium-ion electrochemical cell as claimed in claim 13, wherein the negative electrode comprises a carbon-based active material.

15. The lithium-ion electrochemical cell as claimed in claim 13, wherein the positive active material comprises one or more of the compounds i) to v):
compound i) of formula LiₓMn_{1-y-z}M′_{y}M″_{z}PO₄, where M′ and M″ are different from each other and are selected from the group consisting of B, Mg, Al, Si, Ca, Ti, V, Cr, Fe, Co, Ni, Cu, Zn, Y, Zr, Nb and Mo, and 0.8≤x≤1.2; 0≤y≤0.6; 0≤z≤0.2;
compound ii) of formula LiₓM_{2-x-y-z-w}M′_{y}M″_{z}M′″_{w}O₂, where M, M′, M″ and M″′ are selected from the group consisting of B, Mg, Al, Si, Ca, Ti, V, Cr, Mn, Fe, Co, Ni, Cu, Zn, Y, Zr, Nb and Mo, provided that M or M′ or M″ or M′″ is selected from Mn, Co, Ni, or Fe; M, M′, M″ and M″′ are different from each other; 0.8≤x≤1.4; 0≤y≤0.5; 0≤z≤0.5; 0≤w≤0.2 and x+y+z+w<2.2;
compound iii) of formula LiₓMn_{2-y-z}M′_{y}M″_{z}O₄, where M′ and M″ are selected from the group consisting of B, Mg, Al, Si, Ca, Ti, V, Cr, Fe, Co, Ni, Cu, Zn, Y, Zr, Nb and Mo; M′ and M″ are different from each other, and 1≤x≤1.4; 0≤y≤0.6; 0≤z≤0.2;
compound iv) of formula LiₓFe_{1-y}M_{y}PO₄, where M is selected from the group consisting of B, Mg, Al, Si, Ca, Ti, V, Cr, Mn, Co, Ni, Cu, Zn, Y, Zr, Nb and Mo; and 0.8≤x≤1.2; 0≤y≤0.6;
compound v) of formula xLi₂MnO₃; (1−x)LiMO₂ where M is selected from Ni, Co and Mn and x≤1.

16. The lithium-ion electrochemical cell as claimed in claim 15, wherein the positive active material comprises the compound i) with x=1; M′ represents at least one cell selected from the group consisting of Fe, Ni, Co, Mg and Zn; 0≤y<0.5 and z=0.

17. The lithium-ion electrochemical cell as claimed in claim 15, wherein the positive active material comprises the compound ii) and
M is Ni;
M′ is Mn;
M″ is Co and
M″′ is selected from the group consisting of B, Mg, Al, Si, Ca, Ti, V, Cr, Fe, Cu, Zn, Y, Zr, Nb and Mo;
0.8≤x≤1.4; 0≤y<0.5; 0≤z≤0.5; 0≤w≤0.2 and x+y+z+w<2.2.

18. The lithium-ion electrochemical cell as claimed in claim 15, wherein the positive active material comprises the compound ii) and M is Ni; M′ is Co; M″ is Al; 1≤x≤1.15; y>0; z>0; w=0.

19. A method of using an electrochemical cell comprising the step of storing or charging or discharging the lithium-ion electrochemical cell as claimed in claim 13, at a temperature of at least 80° C.

20. A method of using an electrochemical cell comprising the step of storing or charging or discharging the lithium-ion electrochemical cell as claimed in claim 13, at a temperature of −20° C. or below.
